(19) United States
(12) Patent Application Publication
(10) Pub. No.: US 2024/0036707 A1
(43) Pub. Date: Feb. 1, 2024

(54) WEB BROWSER WITH INACTIVE TABS THAT DO NOT INCLUDE CLOSE BUTTON

(71) Applicant: GOOGLE LLC, Mountain View, CA (US)

(72) Inventors: Omolola Adetayo Adams, Fremont, CA (US); Theresa Marie Sullivan, Los Gatos, CA (US); Sirisha Kavuluru, Fremont, CA (US); Sara Hee Shin Park, Los Angeles, CA (US); Xiangqi Liu, Seattle, WA (US)

(21) Appl. No.: 18/361,101

(22) Filed: Jul. 28, 2023

Related U.S. Application Data
(60) Provisional application No. 63/369,744, filed on Jul. 28, 2022.
(60) Provisional application No. 63/369,756, filed on Jul. 28, 2022.

(51) Int. Cl. G06F 3/0483; G06F 3/0486

(52) U.S. Cl. CPC G06F 3/0483; G06F 3/0486

(57) ABSTRACT

A method includes displaying a web browser, the web browser including a viewing panel displaying first content, a first tab associated with the first content, the first tab displaying a first close button, and a second tab. The method includes receiving a selection of the second tab. The method includes, in response to receiving the selection of the second tab, causing the viewing panel to display second content associated with the second tab, causing the second tab to present a second close button that was not presented before the selection of the second tab was received, and causing the first tab to stop displaying the first close button.

### PRIORITY CLAIM

This application claims the benefit of priority based on U.S. Provisional Application No. 63/369,744, filed on Jul. 28, 2022, and U.S. Provisional Application No. 63/369,756, filed on Jul. 28, 2022, the disclosures of both of which are hereby incorporated by reference in their entireties.

### TECHNICAL FIELD

This description relates to web browsers.

### BACKGROUND

Web browsers can present multiple tabs to enable users to switch between content received from multiple websites. With a large number of tabs, space limitations on a display of a computing system presenting the web browser can lead to input errors.

### SUMMARY

A web browser can stop presenting close buttons on some of the tabs. Stopping presentation of the close button reduces the area occupied by each tab, enabling more tabs to be presented by the web browser. Stopping presentation of the close buttons also prevents accidental closure of the tabs.

The details of one or more implementations are set forth in the accompanying drawings and the description below. Other features will be apparent from the description and drawings, and from the claims.

### BRIEF DESCRIPTION OF THE DRAWINGS

FIG. 1A shows a web browser with multiple tabs.

FIG. 1B shows a web browser with multiple tabs and a cursor in an address bar of the web browser.

FIG. 2A shows a tab strip included in the web browser of FIG. 1.

FIG. 2B shows the tab strip of FIG. 2A after tabs included in the tab strip have been slid horizontally.

FIG. 2C shows the tab strip of FIGS. 2A and 2B after further horizontal sliding of the tabs.

FIG. 3A shows the web browser with multiple tabs.

FIG. 3B shows the web browser after a user has closed an active tab.

FIG. 3C shows the web browser after the user has selected an undo button to restore content associated with the active tab that was closed.

FIG. 4A shows a split tab strip with gradients to indicate that more tabs are available.

FIG. 4B shows a singular tab strip with a gradient to indicate that more tabs are available.

FIG. 5A shows a tab strip with multiple tabs.

FIG. 5B shows the tab strip with a group indicated after the user begins sliding the active tab.

FIG. 5C shows the tab strip after the user has continued sliding the active tab.

FIG. 5D shows the tab strip after the user has continued sliding the active tab.

FIG. 5E shows the tab strip after the user has continued sliding the active tab.

FIG. 5F shows the tab strip after the user has finished sliding the active tab.

FIG. 5G shows the active tab stop presenting a close button in response to the user sliding the active tab.

FIG. 6 shows an example of a computer device and a mobile computer device that can be used to implement the techniques described here.

FIG. 7 is a flowchart showing a method performed by a computing device.

Like reference symbols in the various drawings indicate like elements.

### DETAILED DESCRIPTION

A web browser can present multiple tabs in addition to content. Each tab can be associated with different content. A tab that is associated with content that is presently displayed in a viewing panel of the web browser can be considered an active tab or focused tab. Tabs other than the active tab, that are associated with content other than the content presently displayed in the viewing panel, can be considered inactive tabs or hidden tabs.

The web browser can respond to selection of a tab, such as the user clicking on a tab, by presenting the content associated with the tab. Tabs can sometimes include close buttons, which can be displayed as an ‘X’. The web browser can respond to selection of the close button, such as clicking on the close button, by closing the tab. Closing the tab can include stopping presenting the tab and/or ending a session with a server that sends the content associated with the tab to the computing device on which the web browser is executing. The close button increases the space on the browser occupied by the tab. The increase in space occupied by the tab reduces the number of tabs that the browser can present.

To reduce the space occupied by the tabs, the web browser can cause some or all of the tabs to stop presenting close buttons. In some examples, the web browser can stop presenting close buttons on tabs other than an active tab for which content is displayed (i.e. stop presenting close buttons on inactive tabs). In some examples, the web browser can determine that a number of tabs in and/or presented by the web browser exceeds a tab threshold, and cause one or more inactive tabs to stop presenting a close button based on the number of tabs exceeding the tab threshold. The web browser can stop presenting a close button on the active tab when the active tab is moving with respect to one or more inactive tabs. In some examples, the web browser disables a search field when the active tab is moving with respect to one or more inactive tabs. In some examples, when the web browser receives input in a search field included in a web browser, the web browser presents content associated with a predetermined page or site, such as a search page.

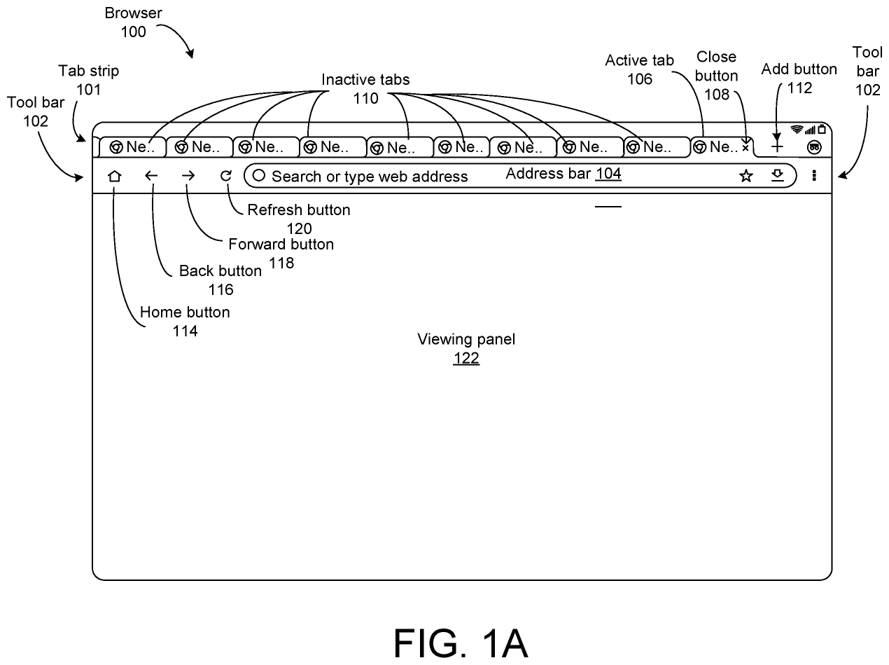

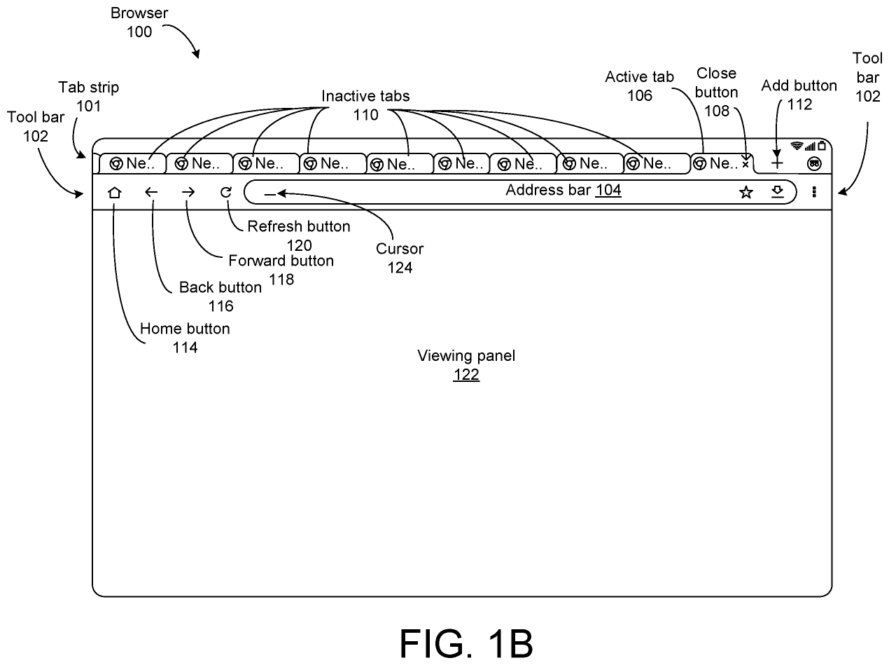

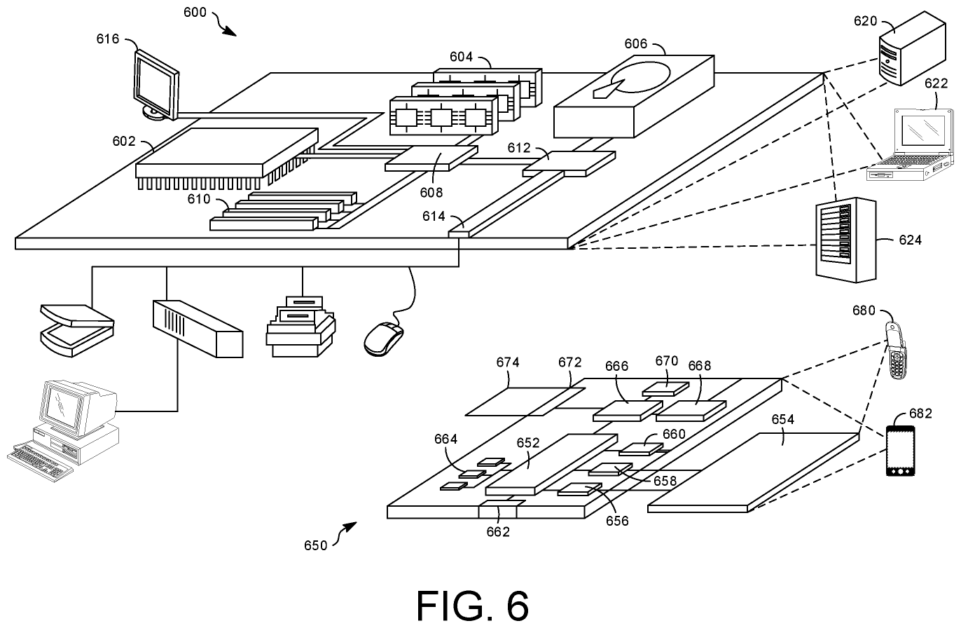

FIG. 1A shows a web browser 100 with multiple tabs 106, 110. The web browser 100 can be presented by a display included in a computing device, such as either of the computing devices 600, 650 shown and described with respect to FIG. 6. The web browser 100 can execute on the computing device.

The web browser 100 can include a tab strip 101 and a tool bar 102. The tab strip 101 and tool bar 102 receive input from a user. The tool bar 102 can include an address bar 104. The address bar 104 can include a field that receives text input, such as a Universal Resource Locator (URL) or a search query. The address bar 104 can also be considered a search field that receives search queries. The web browser 100 can respond to receiving text input, such as a URL or search query, into the address bar 104, by presenting content associated with the URL or search query. The web browser 100 can receive the content associated with the URL or search query from a remote computing device, such as a server associated with the URL or a search engine that provides search results in response to a search query. The web browser 100 can provide the content associated with the URL or search query within a viewing panel 122.

The tab strip 101 can include multiple tabs 106, 110. The tab strip 101 can include an active tab 106. The active tab 106 can be associated with the content presented within the viewing panel 122. In some examples, the active tab 106 can be considered to be an active state. A tab that is in an active state is associated with content displayed in viewing panel 122, and/or associated with an address (such as a Universal Resource Locator) that identifies the content. The active tab 106 can include a close button 108. The web browser 100 can respond to the user selecting and/or clicking on the close button 108 by closing the active tab 106 (such as by rendering the active tab 106 no longer visible and presenting content in the viewing panel 122 that is associated with one of the previously-inactive tabs 110). In some examples, the tabs 110 can be considered to be in an inactive state. Tabs in an inactive state are not associated with content presented in the viewing panel 122. Tabs can transition to the active state when the viewing panel 122 displays content associated with the tab.

In the example shown in FIG. 1A, the inactive tabs 110 do not include close buttons. The lack of close buttons reduces the area occupied by the inactive tabs 110, allowing more inactive tabs 110 to be included in the tab strip 101. The lack of close buttons also reduces the likelihood that a user will accidentally close one of the inactive tabs 110 when the user intends to convert an inactive tab 110 to the active tab by selecting and/or clicking on the inactive tab 110. A user can select the close button included the active tab 106, such as by clicking on the close button 108, and the web browser web browser 100 can respond to the selection of the close button 108 by closing and/or removing the active tab 106 and causing one of the inactive tabs 110 to become a new active tab. The web browser 100 can present, within the viewing panel 122 content associated with the new active tab.

In some examples, the active tab 106 can be considered a first tab, and one of the inactive tabs 110 can be considered a second tab. The web browser 100 can include the viewing panel 122 displaying first content, the first tab (which is an example of the active tab 106), and a second tab (which is an example of one of the inactive tabs 110). The first tab is associated with the first content. The web browser 100 may have retrieved the first content from a first remote server associated with a first URL that is presented in the address bar 104 and/or is associated with the first tab. The first tab includes the close button 108, which can be considered a first close button. The web browser 100 receives a selection of the second tab. In response to receiving the selection of the second tab, the web browser 100 causes the viewing panel 122 to display second content. The second content is associated with the second tab. The web browser 100 may have retrieved the second content from a second remote server associated with a second URL that is presented in the address bar 104 (after selection of the second tab) and/or is associated with the second tab. In response to receiving the selection of the second tab, the web browser 100 causes the second tab to present a second close button that was not presented before the selection of the inactive tab was received. In response to receiving the selection of the second tab, the web browser 100 causes the first tab to stop displaying and/or presenting the first close button.

The tab strip 101 can include an add button 112. The web browser 100 can respond to the user selecting the add button 112 by creating a new tab. When the web browser 100 creates the new tab, the viewing panel 122 can be blank, and/or present icons associated with a home screen webpage and/or the address bar 104 can be blank.

The tool bar 102 can include a home button 114. The web browser 100 can respond to the user selecting the home button 114 by returning to a home page. The tool bar 102 can include a back button 116. The web browser 100 can respond to the user selecting the back button 116 by returning the address bar 104 and viewing panel 122 to a previous page. The tool bar 102 can include a forward button 118. The web browser 100 can respond to a user selecting the forward button 118 by returning the address bar 104 and viewing panel 122 to a page in an opposite direction within a navigation hierarchy as the back button 116. The tool bar 102 can include a refresh button 120. The web browser 100 can respond to a user selecting the refresh button 120 by requesting content associated with the URL included in the address bar 104 and rendering the content in the viewing panel 122.

FIG. 1B shows the web browser 100 with multiple tabs 106, 110 and a cursor 124 in the address bar 104 of the web browser 100. The computing system may have located the cursor 124 in response to input from a mouse or other human-interface device (HID) directed to a location on the display associated with the address bar 104. The address bar 104 may or may not present text.

In response to receiving input in the address bar 104, which can be considered a search field, the web browser 100 can cause the viewing panel 122 to display content other than the content associated with the active tab 106. In an example in which first content is associated with the active tab 106 and second content is associated with one of the inactive tabs 110, the content other than the content associated with the active tab 106 that the web browser 100 causes the viewing panel 122 to present can be considered third content. In some examples, the input in response to which the web browser 100 causes the viewing panel 122 to display the third content is the placement of the cursor 124 in the address bar 104. In some examples, the input in response to which the web browser 100 causes the viewing panel 122 to display the third content is entering text (such as typing) into the address bar 104.

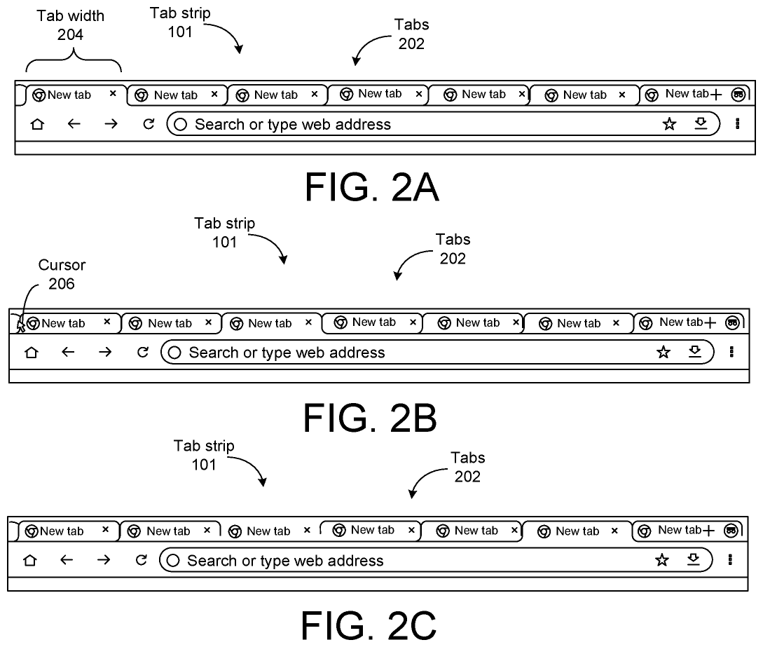

In some examples, a number of tabs, including an active tab and inactive tabs, exceeds a number of tabs that can be displayed on the browser 100. The web browser 100 can display a subset of the tabs. In some examples, the web browser 100 can respond to directional movement, such as the user dragging and/or sliding one of the tabs, by sliding or moving the tabs horizontally. The horizontal sliding or moving of the tabs by the web browser 100 causes the tabs to move together. When the tabs slide to the right, the right-most tab ceases to be displayed, and a new tab is displayed on the left of the tab strip 101. When the tabs slide to the left, the left-most tab ceases to be displayed, and a new tab is displayed on the right of the tab strip 101. An example of sliding the tabs is shown in FIGS. 2A, 2B, and 2C.

FIG. 2A shows the tab strip 101 included in the web browser of FIG. 1. FIG. 2A also shows the tool bar 102 (not labeled in FIG. 2A) below the tab strip 101. In this example, a number of tabs 202 that are active on the tab strip 101 exceeds a maximum number of tabs that can be displayed on the tab strip 101. A user can slide the tabs 202 horizontally, to the left or to the right, such as by dragging a cursor or other input method along one of the tabs 202, to cause the tool bar to display different tabs 202. The tab strip 101 can move the tabs 202 discrete distances, such as a single tab width 204. In some examples, the tab strip 101 moves the tabs 202 continuously, rather than discrete distances. The continuous movement of the tabs 202 can either allow for partial overlaps between tabs, or can be only for visual effect, with the final locations of the tabs 202 being changes by the discrete distances such as the single tab width 204.

FIG. 2B shows the tab strip 101 of FIG. 2A after tabs 202 included in the tab strip 101 have been slid horizontally. FIG. 2B also shows the tool bar 102 (not labeled in FIG. 2B) below the tab strip 101. The user provided the sliding input to the tabs 202 using a cursor 206. The user may have controlled the cursor 206 using a mouse or a touchscreen. In some examples, the web browser 100 responds to the sliding input by sliding the tabs 202 a discrete number of tab widths 204, so that full tabs 202 are still displayed.

FIG. 2C shows the tab strip 101 of FIGS. 2A and 2B after further horizontal sliding of the tabs. FIG. 2C also shows the tool bar 102 (not labeled in FIG. 2C) below the tab strip 101. The web browser 100 has again slid the tabs 202 a discrete number of tab widths 204, so that full tabs 202 are still displayed.

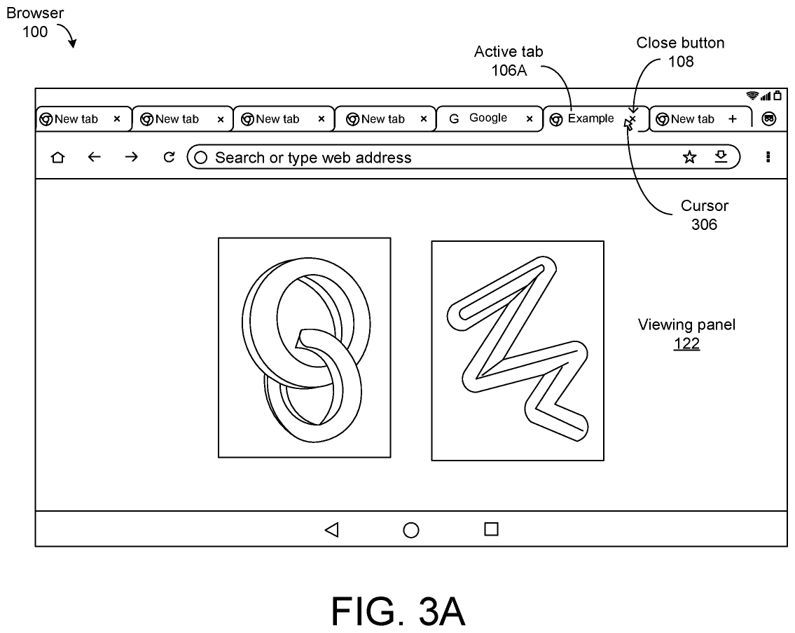

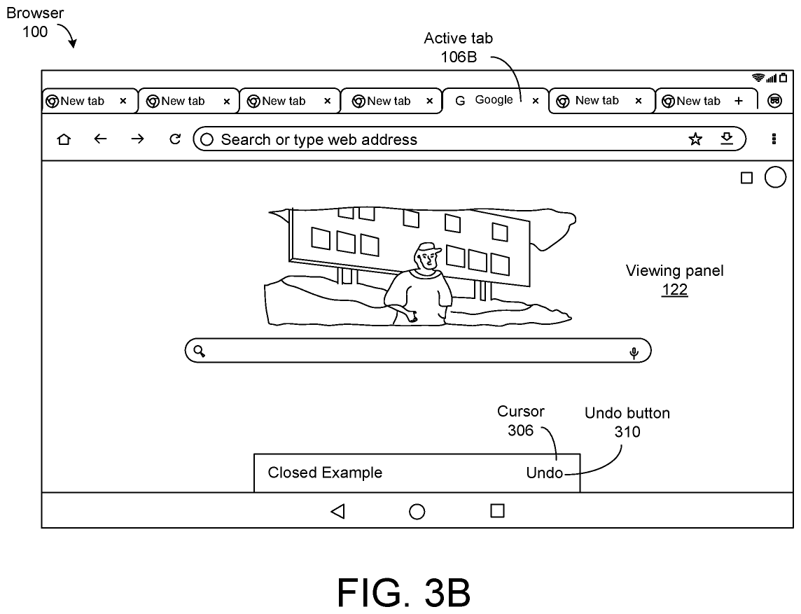

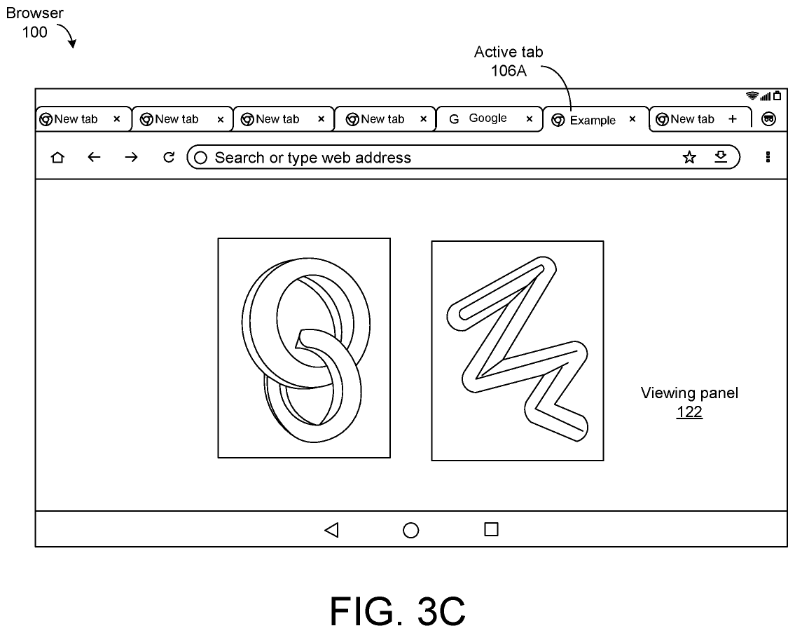

As discussed above, an active tab is a tab that is associated with content that is displayed on the viewing panel 122. The active tab can be considered a first tab. When the web browser 100 closes the active tab, such as in response to the user selecting the close button in the active tab or inactive tab, the web browser 100 can cause the viewing panel 122 to stop presenting content associated with the active tab or first tab and begin presenting content associated with a second, previously inactive, tab. The second, previously inactive, tab, then becomes the active tab. In some examples, the web browser 100 can restore the original active tab or first tab in response to user input (such as the user selecting an udo button) and cause the viewing panel 122 to present the content associated with the original focus tab or first tab. FIGS. 3A, 3B, and 3C show closure and restoration of an active tab.

FIG. 3A shows the web browser 100 with multiple tabs. The user can close an active tab 106A, which is associated with the content presented by the viewing panel 122, by selecting the close button 108 included in the active tab 106A, such as with a cursor 306. The active tab 106A can be considered a first tab.

FIG. 3B shows the web browser 100 after a user has closed the active tab. The web browser 100 can present content in the viewing panel 122 that is associated with a different tab, which is now considered the active tab 106B. The tab that is now considered the active tab 106B can also be considered a second tab. The viewing panel 122 can also present an undo button 310. The user can select the undo button 310 with the cursor 306.

FIG. 3C shows the web browser 100 after the user has selected the undo button 310 to restore content associated with the active tab 106A that was closed. The web browser 100 has responded to the user selecting the undo button 310 by restoring the active tab 106A and presenting content in the viewing panel 122 that is associated with the restored active tab 106A. Allowing the user to select the undo button 310 and restore the active tab 106A can correct mistaken selections and/or clicks on the close button 108.

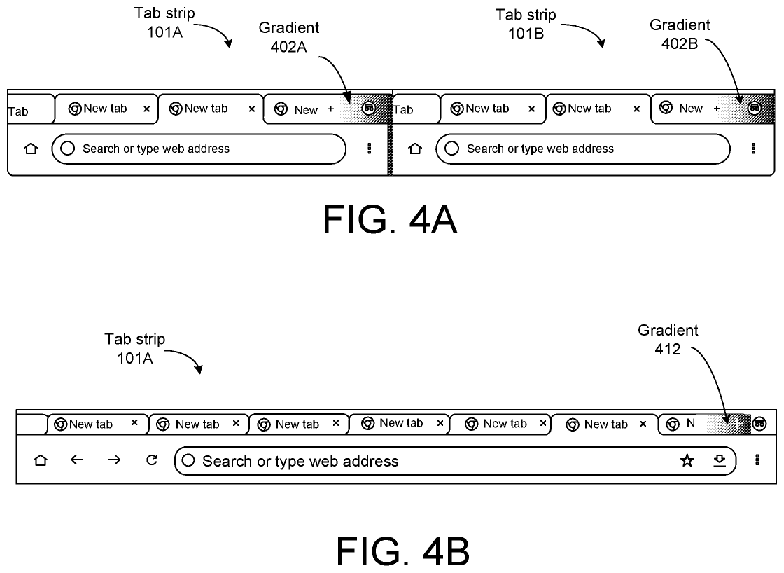

In some examples, a gradient, or change of color, at an end portion of a tab strip indicates that more tabs are available on the web browser 100. FIGS. 4A and 4B show examples of tab strips with gradients.

FIG. 4A shows a split tab strip 101A, 101B with gradients 402A, 402B to indicate that more tabs are available. FIG. 4A also shows tool bars 102 (not labeled in FIG. 4A) below the tab strips 101A, 101B. The gradients 402A, 402B can include gradual changes of color and/or tone that indicate more tabs are available than are shown by the tab strip 101A, 101B.

FIG. 4B shows a singular tab strip 101 with a gradient 412 to indicate that more tabs are available. FIG. 4B also shows the tool bar 102 (not labeled in FIG. 4B) below the tab strip 101. The gradient 412 can also include a gradual change of color and/or tone that indicates more tabs are available than are shown by the tool bar.

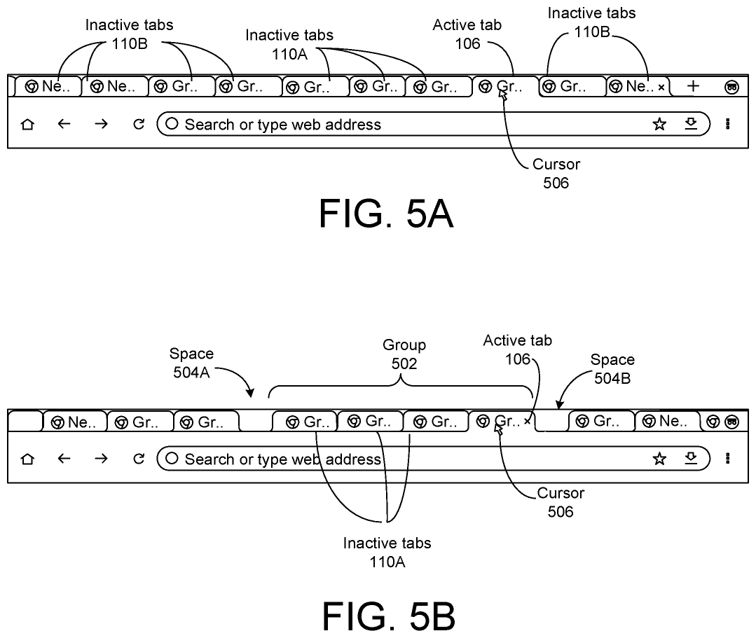

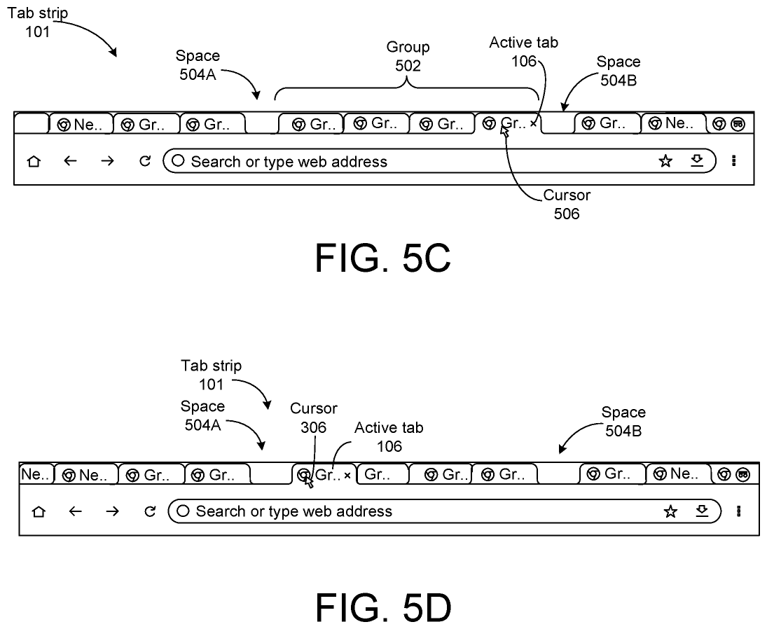

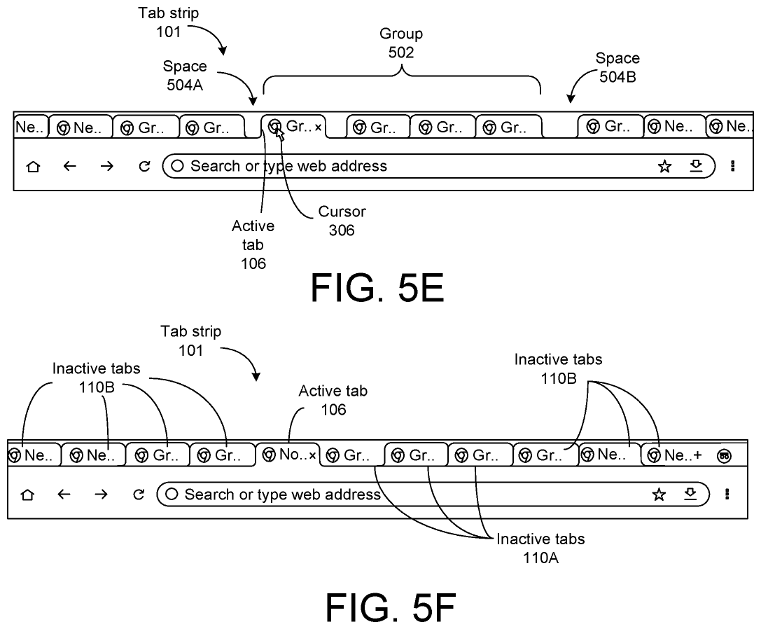

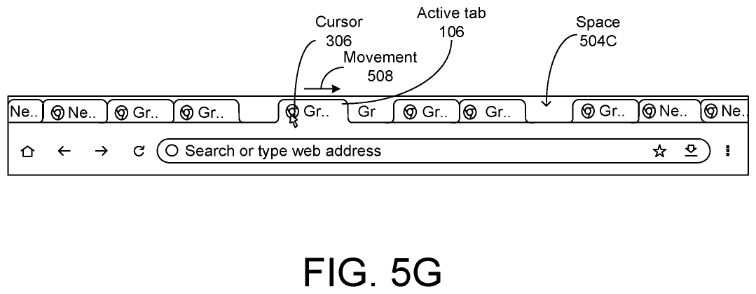

In some examples, the web browser 100 can respond to user input by sliding or moving a tab with respect to other tabs. The user input to which the web browser 100 responds by sliding or moving the tab can include, for example, a drag input. FIGS. 5A through 5G show the web browser 100 sliding and/or moving a tab with respect to other tabs.

FIG. 5A shows a tab strip 101 with multiple tabs 106, 110A, 110B. FIG. 5A also shows the tool bar 102 (not labeled in FIG. 5A) below the tab strip 101. The inactive tabs 110A can be in a same group 502 as the active tab 106. The inactive tabs 110B can be in a different group(s) than the active tab 106. The user can provide sliding input to the active tab 106 using a cursor 506 to move the active tab 106 within the group. The web browser 100 can respond to the sliding input by moving the active tab 106 horizontally within the group 502.

FIG. 5B shows the tool bar with a group 502 indicated after the user begins sliding the active tab 106. As described herein (above and below), sliding can also be considered dragging. FIG. 5B also shows the tool bar 102 (not labeled in FIG. 5B) below the tab strip 101. The tab strip 101 can present space 504A, 504B between the tabs 106, 110A that are in the group 502 and the tabs 110B that are not in the group 502. The space 504A, 504B can indicate that the tabs 106, 110A are in the same group 502.

FIG. 5C shows the tab strip 101 after the user has continued sliding the active tab 106. FIG. 5C also shows the tool bar 102 (not labeled in FIG. 5C) below the tab strip 101. The sliding can cause the active tab 106 to move left with respect to the other tabs 110A, 110B. The tab strip 101 can continue presenting space 504A, 504B between the tabs 106, 110A that are in the group 502 and the tabs 110B that are not in the group 502.

FIG. 5D shows the tab strip 101 after the user has continued sliding the active tab 106. FIG. 5D also shows the tool bar 102 (not labeled in FIG. 5D) below the tab strip 101. The sliding has continued to cause the active tab 106 to move left with respect to the other tabs 110A, 110B. The tab strip 101 continues presenting space 504A, 504B between the tabs 106, 110A that are in the group 502 and the tabs 110B that are not in the group 502.

FIG. 5E shows the tab strip 101 after the user has continued sliding the active tab 106. FIG. 5E also shows the tool bar 102 (not labeled in FIG. 5E) below the tab strip 101. The active tab 106 is now to the left of all of the other tabs 110A that are in the same group 502 as the active tab 106. The tab strip 101 continues presenting space 504A, 504B between the tabs 106, 110A that are in the group 502 and the tabs 110B that are not in the group 502.

FIG. 5F shows the tab strip 101 after the user has finished sliding the active tab 106. FIG. 5F also shows the tool bar 102 (not labeled in FIG. 5F) below the tab strip 101. The sliding of the active tab 106 is complete, and the tab strip 101 has removed the space between the tabs 106, 110A that are in the group 502 and the tabs 110B that are not in the group 502. In some examples, the web browser 100 has also removed the tab 106 from the group 502.

In some examples the web browser 100 stops presenting a close button within an active tab while the user is sliding the active tab, and/or while the active tab is sliding. Stopping presenting the close button within the active tab while the active tab is sliding saves space within the web browser 100. The user will not activate and/or select the close button while the active tab is sliding, rendering the close button unnecessary while the active tab is sliding.

FIG. 5G shows the active tab 106 stop presenting a close button in response to the user sliding the active tab 106. In the example shown in FIG. 5G movement 508 of the active tab 106 is to the right in response to movement by a cursor 306 to the right. Movement of the active tab 106 can also be to the left in response to movement by the cursor 306 to the left. The web browser 100 responds to the movement 508 of the active tab 106 by ceasing and/or stopping presentation of the close button within the active tab 106. A close button is not shown within the active tab 106 in the example of FIG. 5G.

In some examples, the web browser 100 can remove a tab from a group, and/or change a group that a tab is a member of, based on movement of the tab beyond a space that bounds the group. In the example of FIG. 5G, the active tab 106 is part of and/or a member of a group. The group of tabs that the active tab 106 is a member of is bounded by the space 504A on the left of the group and the 505B// on the right of the group. The web browser 100 can, in response to movement 508 of the cursor 306, move the active tab 106 beyond and/or to the right of the space 504B (and/or beyond or to the left of the space 504A). In response to the movement 508 of the active tab 106 beyond the space 504B (and/or beyond the space 504A), the web browser 100 can remove the active tab 106 from the group of tabs that is bounded by the spaces 504A, 504B. In some examples, the web browser 100 can also add the active tab 106 to a group of tabs that is to the right of the space 504B (or to the group of tabs that is to the left of the space 504A if the movement of the active tab 106 is to the left beyond the space 504A).

FIG. 6 shows an example of a generic computer device 600 and a generic mobile computer device 650, which may be used with the techniques described here. Computing device 600 is intended to represent various forms of digital computers, such as laptops, desktops, tablets, workstations, personal digital assistants, televisions, servers, blade servers, mainframes, and other appropriate computing devices. Computing device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. The processor 602 can be a semiconductor-based processor. The memory 604 can be a semiconductor-based memory. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. The display 616 can render, present, and/or display the web browser 100. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. The memory 604 can include a non-transitory computer-readable storage medium comprising instructions stored thereon that, when executed by at least one processor, such as the processor 602, are configured to cause the computing device 600 to perform any combination of the methods, functions, and/or techniques described herein. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 can render, present, and/or display the web browser 100. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can include a non-transitory computer-readable storage medium comprising instructions stored thereon that, when executed by at least one processor, such as the processor 652, are configured to cause the computing device 650 to perform any combination of the methods, functions, and/or techniques described herein. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smart phone 682, personal digital assistant, or other similar mobile device.

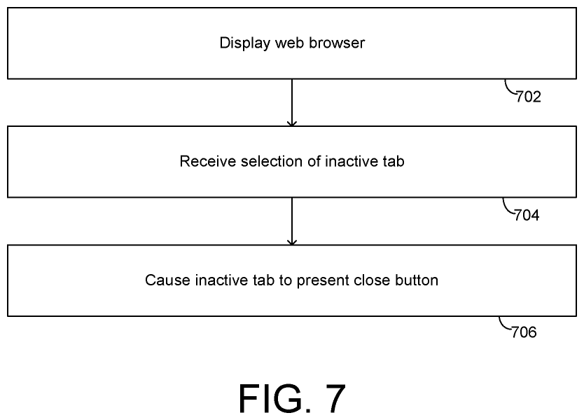

FIG. 7 is a flowchart showing a method performed by a computing device. The method can be performed by a computing device such as either of the computing devices 600, 650 executing the web browser 100. The method can include displaying a web browser (702). The web browser can include a viewing panel displaying first content, a first tab (or active tab) associated with the first content, the first tab displaying a first close button, and a second tab (or inactive tab). The method can include receiving a selection of the second tab (or inactive tab) 704. The method can include causing the second tab (or inactive tab) to present a close button (706). In some examples, the method includes, in response to receiving the selection of the second tab (or inactive tab), causing the viewing panel to display second content associated with the second tab (or inactive tab), causing the second tab (or inactive tab) to present a second close button that was not presented before the selection of the second tab (or inactive tab) was received, and causing the first tab (or active tab) to stop displaying the first close button.

In some examples, the method further includes before receiving the selection of the second tab, generating a third tab in the web browser, determining that a number of tabs in the web browser exceeds a tab threshold, and based on determining that the number of tabs exceeds the tab threshold, causing the second tab to stop displaying the second close button.

In some examples, the method further includes, in response to receiving drag input, moving the first tab with respect to the second tab, and causing the first tab to stop presenting the first close button while the second tab is moving.

In some examples, the method further includes, in response to receiving drag input, moving the first tab with respect to the second tab, and while moving the first tab with respect to the second tab, disabling a search field, the search field being included in the web browser.

In some examples, the method further includes receiving drag input associated with the first tab, in response to receiving the drag input associated with the first tab, moving the first tab with respect to the second tab, and while moving the first tab with respect to the second tab, causing the first tab to stop presenting the first close button, and disabling a search field, the search field being included in the web browser.

In some examples, the method further includes receiving input in a search field included in the web browser, and in response to receiving the input in the search field, causing the viewing panel to display third content, the third content not being associated with the first tab.

In some examples, the causing the viewing panel to display second content associated with the second tab includes transitioning the second tab from an inactive state to an active state.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method comprising:
displaying a web browser, the web browser including:
a viewing panel displaying first content;
a first tab associated with the first content, the first tab displaying a first close button; and
a second tab;
receiving a selection of the second tab; and
in response to receiving the selection of the second tab:
causing the viewing panel to display second content associated with the second tab;
causing the second tab to present a second close button that was not presented before the selection of the second tab was received; and
causing the first tab to stop displaying the first close button.

2. The method of claim 1, further comprising, before receiving the selection of the second tab:
generating a third tab in the web browser;
determining that a number of tabs in the web browser exceeds a tab threshold; and
based on determining that the number of tabs exceeds the tab threshold, causing the second tab to stop displaying the second close button.

3. The method of claim 1, further comprising, in response to receiving drag input:
moving the first tab with respect to the second tab; and
causing the first tab to stop presenting the first close button while the second tab is moving.

4. The method of claim 1, further comprising:
in response to receiving drag input, moving the first tab with respect to the second tab; and
while moving the first tab with respect to the second tab, disabling a search field, the search field being included in the web browser.

5. The method of claim 1, further comprising:
receiving drag input associated with the first tab;
in response to receiving the drag input associated with the first tab, moving the first tab with respect to the second tab; and
while moving the first tab with respect to the second tab:
causing the first tab to stop presenting the first close button; and
disabling a search field, the search field being included in the web browser.

6. The method of claim 1, further comprising:
receiving input in a search field included in the web browser; and
in response to receiving the input in the search field, causing the viewing panel to display third content, the third content not being associated with the first tab.

7. The method of claim 1, wherein the causing the viewing panel to display second content associated with the second tab includes transitioning the second tab from an inactive state to an active state.

8. A non-transitory computer-readable storage medium comprising instructions stored thereon that, when executed by at least one processor, are configured to cause a computing device to:
display a web browser, the web browser including:
a viewing panel displaying first content;
a first tab associated with the first content, the first tab displaying a first close button; and
a second tab;
receive a selection of the second tab; and
in response to receiving the selection of the second tab:
cause the viewing panel to display second content associated with the second tab;
cause the second tab to present a second close button that was not presented before the selection of the second tab was received; and
cause the first tab to stop displaying the first close button.

9. The non-transitory computer-readable storage medium of claim 8, wherein the instructions are further configured to cause the computing device to, before receiving the selection of the second tab:
generate a third tab in the web browser;
determine that a number of tabs in the web browser exceeds a tab threshold; and
based on determining that the number of tabs exceeds the tab threshold, cause the second tab to stop displaying the second close button.

10. The non-transitory computer-readable storage medium of claim 8, wherein the instructions are further configured to cause the computing device to, in response to receiving drag input:
move the first tab with respect to the second tab; and
cause the first tab to stop presenting the first close button while the second tab is moving.

11. The non-transitory computer-readable storage medium of claim 8, wherein the instructions are further configured to cause the computing device to:
in response to receiving drag input, move the first tab with respect to the second tab; and
while moving the first tab with respect to the second tab, disable a search field, the search field being included in the web browser.

12. The non-transitory computer-readable storage medium of claim 8, wherein the instructions are further configured to cause the computing device to:
receive drag input associated with the first tab;
in response to receiving the drag input associated with the first tab, move the first tab with respect to the second tab; and
while moving the first tab with respect to the second tab:
cause the first tab to stop presenting the first close button; and
disable a search field, the search field being included in the web browser.

13. The non-transitory computer-readable storage medium of claim 8, wherein the instructions are further configured to cause the computing device to:
receive input in a search field included in the web browser; and
in response to receiving the input in the search field, cause the viewing panel to display third content, the third content not being associated with the first tab.

14. The non-transitory computer-readable storage medium of claim 8, wherein the causing the viewing panel to display second content associated with the second tab includes transitioning the second tab from an inactive state to an active state.

15. A computing device comprising:
at least one processor; and
a non-transitory computer-readable storage medium comprising instructions stored thereon that, when executed by the at least one processor, are configured to cause the computing device to:
display a web browser, the web browser including:
a viewing panel displaying first content;
a first tab associated with the first content, the first tab displaying a first close button; and
a second tab;
receive a selection of the second tab; and
in response to receiving the selection of the second tab:
cause the viewing panel to display second content associated with the second tab;
cause the second tab to present a second close button that was not presented before the selection of the second tab was received; and
cause the first tab to stop displaying the first close button.

16. The computing device of claim 15, wherein the instructions are further configured to cause the computing device to, before receiving the selection of the second tab:
generate a third tab in the web browser;
determine that a number of tabs in the web browser exceeds a tab threshold; and
based on determining that the number of tabs exceeds the tab threshold, cause the second tab to stop displaying the second close button.

17. The computing device of claim 15, wherein the instructions are further configured to cause the computing device to, in response to receiving drag input:
move the first tab with respect to the second tab; and
cause the first tab to stop presenting the first close button while the second tab is moving.

18. The computing device of claim 15, wherein the instructions are further configured to cause the computing device to:
in response to receiving drag input, move the first tab with respect to the second tab; and
while moving the first tab with respect to the second tab, disable a search field, the search field being included in the web browser.

19. The computing device of claim 15, wherein the instructions are further configured to cause the computing device to:
receive drag input associated with the first tab;
in response to receiving the drag input associated with the first tab, move the first tab with respect to the second tab; and
while moving the first tab with respect to the second tab:
cause the first tab to stop presenting the first close button; and
disable a search field, the search field being included in the web browser.

20. The computing device of claim 15, wherein the instructions are further configured to cause the computing device to:
receive input in a search field included in the web browser; and
in response to receiving the input in the search field, cause the viewing panel to display third content, the third content not being associated with the first tab.
